(19) United States
(12) Patent Application Publication
(10) Pub. No.: US 2006/0282361 A1
(43) Pub. Date: Dec. 14, 2006

(54) Electronic trading system with market-centered display and dynamic price tracking

(76) Inventors: Jay M. Twery, Evanston, IL (US); Steven W. Wolf, Chicago, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/412,469

(22) Filed: Apr. 27, 2006

Related U.S. Application Data
(60) Provisional application No. 60/675,141, filed on Apr. 27, 2005.

(51) Int. Cl. G06Q 40/00

(52) U.S. Cl. 705/35

(57) ABSTRACT

A system for electronic trading enables users to trade financial instruments by displaying information relating to financial instruments in a market-centered manner, tracking user selections of price and quantity of contracts for the financial instrument, and initiating placement of a user-specified order as the market changes. The system includes a user system that communicates market information to a user via a display. The display includes a price column for dynamically communicating market prices and an order area. The order area includes indicators that identify the prices in the price column representing the market, and order selection blocks that enable a user to identify a price and/or quantity for tracking or for placing an order. Once identified, the system tracks the price and quantity as the price changes with the market so that a user may command the system to initiate placement of an order for the identified price and quantity.

### CROSS-REFERENCE TO RELATED APPLICATIONS

This patent application claims the benefit of the filing date of U.S. Provisional Patent Application No. 60/675,141, filed Apr. 27, 2005, and entitled “Electronic Trading System with Market-Centered Display and Dynamic Price Tracking,” which is incorporated herein by reference.

### BACKGROUND

Throughout the world there are many exchanges that facilitate electronic trading of financial instruments, which include anything that can be traded with a price and/or quantity, such as stocks, bonds, futures, and other products. This electronic trading allows traders to participate remotely in the market. Traders may communicate with these exchanges using terminals or computers through data lines, over network communication servers, and the like. Software is used to create interactive trading screens or displays through which the traders may obtain market information, monitor market changes, and manage orders.

Most exchanges supply to and require from traders virtually the same information. For example, information relating to the offers to purchase (“bids”) and offers to sell (“asks”), such as the prices for bids and asks and the quantities at those prices that are available in the market, are generally available in real-time from most exchanges. In addition, the exchanges facilitating electronic trading provide interfaces, the specifications of which are available to all users.

However, the client software used in electronic trading (“electronic trading software”) may vary in the way in which it presents information to a user, such as how the market is represented and the way in which it allows orders to be placed with an exchange. Some existing software presents only the best bid and ask prices, and perhaps the quantities available at the best bid and ask prices, respectively. To help ensure that orders are entered at the proper price, these systems initiate order placement by allowing a user to create and submit an order ticket specifying the desired price and quantity. Such systems do not enable rapid initiation of order placement because separate steps are needed to create the order ticket and to submit the order. Other existing software presents the quantities available for the best bid and ask prices along and aligned with a static column of prices. If the desired quantity is predefined, these systems allow a user to place an order by clicking on the desired price. However, these systems do not give the user a consistent view of the market because the display of information created by the electronic trading software does not always allow the best bids and asks to be viewed without a user-initiated re-centering of the display. In addition, such electronic trading software requires a great deal of screen space for the display, which may make it difficult to adequately present all the information a user may need.

### SUMMARY

A system for electronic trading (the “System”) is presented. The System enables users to trade financial instruments by displaying information relating to financial instruments in a market-centered manner, tracking user selections of price and quantity of contracts for the financial instrument, and initiating the placement of a user-specified order for the contracts as the market changes. The market for a financial instrument may be represented in terms of price information for one or more of the best (lowest) offers to sell a contract (each an “ask”), and/or one or more of the best (highest) offers to buy the contract (each a “bid”) available in the market. In addition, the market may be represented by one or more indicators that indicate the number of contracts available for sale (the “ask quantity”) and purchase (the “bid quantity”) in the market.

The System communicates the market to a user in real-time, and consistently in the approximate center of a display (such as that created by a computer monitor) so that even though the prices of the best bids and asks change with the market, the best bids and asks are consistently maintained in the center of the display. Thus, the System provides a view of the market in which price changes are represented dynamically. In addition, the System may maintain or “track” a user-selected price in the display, even as the market changes, until the selection is changed or canceled. When “tracking,” the electronic trading system identifies and presents the user-selected price (and, possibly a user-selected bid or ask quantity), and continues to identify and present the selected price over time and despite changes in the market.

To present market-related data and other information relating to the trading of financial instruments, and to allow price tracking and order placement, the electronic trading system may include one or more user systems. A user system generally includes an interface component, an order component, and a communication component and may be in direct or indirect communication with one or more electronic exchanges. The communication component enables communication with the electronic exchanges, obtains data relating to the market from an exchange and communicates this data to the interface component for communication to a user. Further, the communication component may communicate information relating to a user-specified order for a financial instrument from the order component to an exchange.

The interface component includes a market data interface module and a user interface. The market data interface module of the interface component processes market-related information to create a market-centered display for communication to a user via the user interface. The market-centered display may include a dynamic price column and an order selection area. The price column is dynamic in that the price levels move up and down and/or change as a function of the market. The order selection area may include several rows, and each row may be approximately horizontally aligned with a price level. In addition, the order selection area may include one or more quantity columns, each of which may correspond to a particular quantity level. The intersection of each row and each quantity column in the order selection area defines an order selection block. Further, the order selection area may include several indicators, which identify price levels in the dynamic price column that correspond to the market for the financial instrument. In general, there is at least one indicator associated with each market price level. Multiple indicators may be associated with each price level with each of the indicators for a particular price level representing a quantity.

The market data interface module, together with the user interface, facilitates order selection by enabling a user to select a price on the dynamic price column, and then to track that selection as the market changes. In addition, the order selection area and the user interface may facilitate order selection by enabling a user to select a quantity in one of the quantity columns that corresponds with a price on the dynamic price column, and then tracks both the price and quantity. A user may select a price and/or quantity by communicating such a selection to the market data interface module through the user interface. In response, the System permits a user to initiate placement of the order with an exchange.

### BRIEF DESCRIPTION OF THE DRAWINGS

The invention can be better understood with reference to the following drawings and description. The components in the figures are not necessarily to scale, emphasis instead being placed upon illustrating the principles of the invention. In the figures, the same reference symbols designate the same parts, components, modules or steps, unless and to the extent indicated otherwise.

FIG. 1 is a functional block diagram of an electronic trading system;

FIG. 2 is a functional block diagram of the user system;

FIG. 3 is a functional block diagram of an interface component;

FIG. 4 is a screen-shot of a market-centered trading display; and

FIG. 5 is a screen-shot of the market-centered trading display of FIG. 4 at a later point in time.

### DETAILED DESCRIPTION

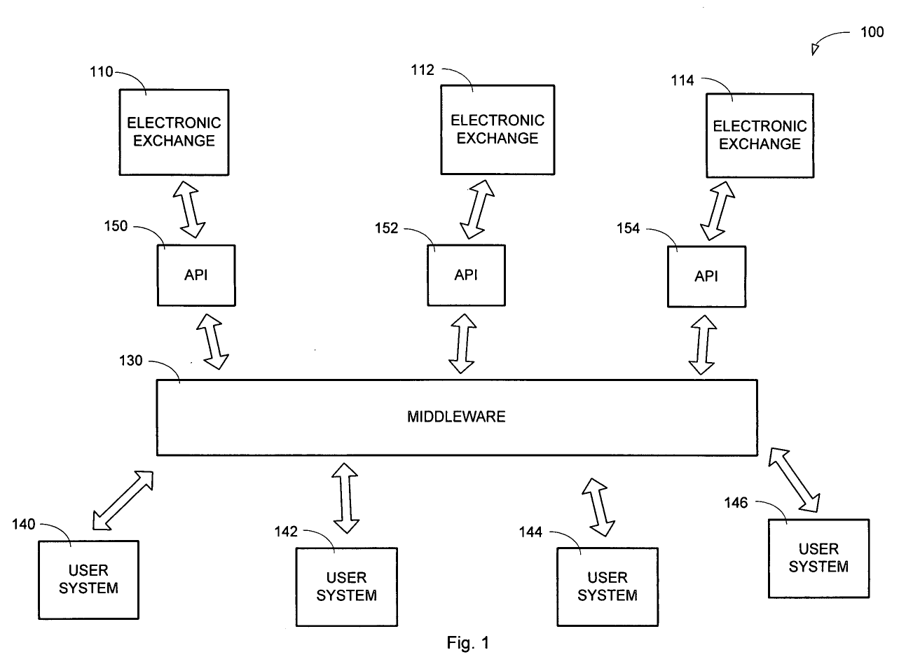

An example of an electronic trading system is shown in FIG. 1. The electronic trading system 100 allows users to trade financial instruments by displaying the market for a financial instrument, and tracking user selections of price and/or quantity for the financial instrument as the market changes. A financial instrument includes anything that can be traded and which includes a price and/or quantity. The smallest unit of a financial instrument that may be traded may be referred to as a “contract.” The market for a financial instrument may be represented in terms price information for one or more of the best (lowest) offers to sell a contract (each an “ask”), and/or one or more of the best (highest) offers to buy the contract (each a “bid”) available in the market. In addition, the market may be represented by one or more indicators that indicate the number of contracts available for sale in the market (the “ask quantity”) and purchase (the “bid quantity”).

The electronic trading system 100 communicates the market in real-time, and consistently in the approximate center of a display accessible to the user. Because the market is central within the display, the display need not be as large as that required by prior systems. The electronic trading system 100 may present the market so that the market is centered on an electronically created display, such as that created by a computer monitor. For example, the electronic trading system 100 may present the market so that the average of the best bid and the best ask available in the market are centered within the a display. Even though the prices of the best bids and asks change with the market, the best bids and asks are consistently maintained in the center of the display, which provides a view of the market in which the changes in the prices are represented dynamically.

In addition, the electronic trading system 100 enables user selection of a price, and then maintains or “tracks” that price in the display, even as the market changes, until the selection is changed or canceled. “Tracking” includes the electronic trading system 100 identifying and presenting to the user a particular user-selected price (and, possibly a user-selected bid or ask quantity), and continuing to identify and present to the user the selected price over time and despite changes in the market, until the user de-selects the price. In addition to providing a user with a visual identification of a particular price, price tracking may allow a user to place orders at a particular price, even though the prices for the contracts are dynamically displayed.

The electronic trading system 100 may include one or more electronic exchanges 110, 112, and 114, middleware 130, and one or more user systems 140, 142, 144, 146. Although three electronic exchanges and four user systems are shown in FIG. 1, the electronic trading system 100 may include any number of user systems and electronic exchanges. The exchanges 110-114 provide an interface, which users may use to trade financial instruments electronically. In general, the exchanges 110-114 (which may be located throughout the world), provide data relating to the market and other information relating to the trading of financial instruments, receive orders, and match bids with asks. In addition, the exchanges 110-114 may perform one or more of the following operations: maintaining order books (which include collections of active orders for a user on a given exchange), positions, and price information, and maintaining and managing trade-related information. Further, the exchanges 110-114 may include backups and redundancy to help ensure consistent system availability.

As shown in FIG. 1, one or more of the user systems 140-146 may communicate with one or more of the electronic exchanges 110-114 indirectly through middleware 130. Alternatively, the user systems 140-146 may communicate with the exchanges 110-114 directly. The user systems 140-146 may communicate with the electronic exchanges 110-114, directly or indirectly through middleware 130 over a variety of links, which may include high speed data lines, high speed communications servers, and networks such as the Internet. Middleware 130 may include hardware and/or software that collectively provides communication among systems. When multiple user systems 140-146 communicate with multiple exchanges 110-114, the middleware 130 may include one or more routers that route communications between the intended exchange and user system. The electronic trading system 100 may also include one or more gateways 150, 152, 154. Each gateway 150-154 may include an application program interface (“API”), or messaging protocol that translates the communications from one or more exchanges 110-114 into a format that may be understood by the environment for which the communication is intended. Furthermore, the gateways may include one or memory devices that store historical user data, such as order books. Alternatively, such historical data may be stored on other memory devices to which the appropriate user system has access.

The user systems 140-146 will be described in terms of a single user system 140. However, the description will apply equally to all such user systems included in an electronic trading system 100, unless otherwise indicated. The user system 140 presents the market for one or more financial instruments in a market-centered display, while maintaining or “tracking” a user-selected price as the market changes. Furthermore, the user system 140 may maintain or track a user selection of quantity as the market changes. The user system 140 may receive data relating to the market for one or more financial instruments from any number of electronic exchanges.

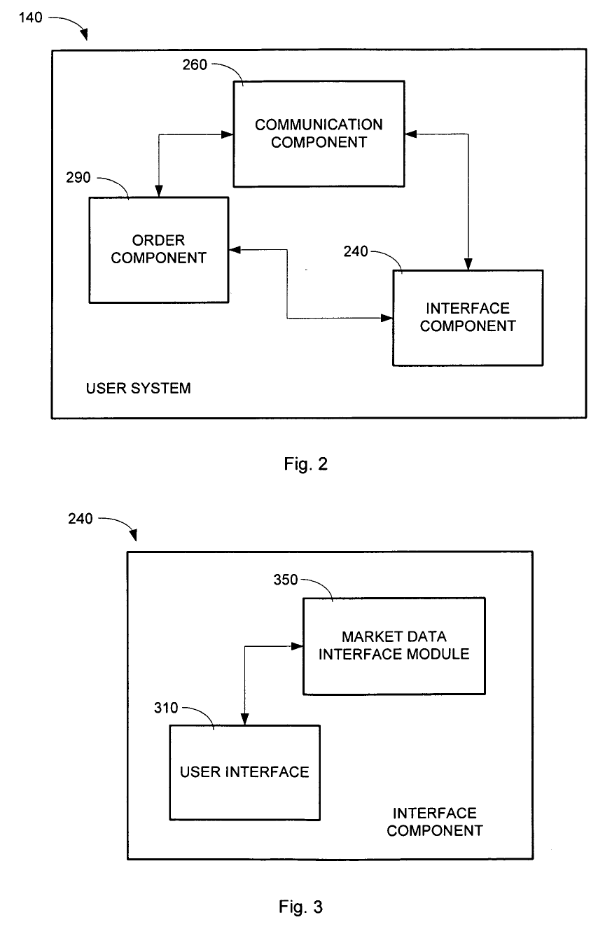

An example of a user system 140 is shown in FIG. 2. The user system 140 may include an interface component 240, an order component 290, and a communication component 260. These components 240, 260, 290 may be implemented in hardware, computer-executable software, or a combination of hardware and software. Each of these components may include or be in communication with one or more processors and/or one or more computer-readable memory devices (not shown). The memory devices may include any type of fixed or removable digital storage device and, if needed, a device for reading the digital storage device, including floppy disks and floppy drives, CD-ROM disks and drives, optical disks and drives, hard-drives, RAM, ROM and any other device or devices for storing digital information. The processor may include any type of device or devices used to process digital information. The one or more processors and memory devices may be internal, external or remote to the order component 290, interface component 240, and/or communication component 260, in any combination. The software may include object code, source code, or any computer-readable code, and may be stored in the one or more processors, and/or memory devices in any combination. Alternatively or additionally, the software may be encoded in a computer-readable electromagnetic signal.

As shown in FIG. 2, each of the components 240, 260, 290 of the user system 140 may include separate components (including hardware and/or software), or alternatively, some or all may be together in a single device, such as a computer, in any combination. Additionally or alternatively, some or all of the components may be on, or in connection with a remote device, such as a server, memory device or the like. The order component 290, interface component 240, and communication component 260 may communicate with each other using any type of electromagnetic communications via any type of channel or network, including microwave, RF, and optical, whether wireless or wired. For example, the software portions of the user system 140 may be created and/or operate in a UNIX® or UNLX®-like operating system, such as the Solaris™ Operating Environment by Sun Microsystems, and any Linux distribution or other minimally portable operating system interface (“POSIX”)-compliant operating system.

The communication component 260 may enable communication with one or more electronic exchanges directly or indirectly through middleware 130 (FIG. 1). The communication component 260 may receive data relating to the market for a financial instrument from an exchange and communicate this data to the interface component 240 for communication to a user. The communication component 260 may also communicate information supplied manually by a user or automatically from a local or remote memory such as log-ons, log-offs, authentication information, and passwords to an exchange. Further, the communication component 260 may communicate information relating to placing an order for a financial instrument, such as price, quantity, and whether the order is for a bid or an ask, (collectively “order information”) from the order component 290 to an exchange (see FIG. 1, 110-114). The communication component 260 may include a modem, router, switch, DSU/CSU (data service unit/channel service unit), bridge, network interface, or hub, or any other device for electromagnetically communicating digital data over a wired or wireless channel or network.

The interface component 240 generally communicates data relating to a market for a financial instrument from an exchange (see FIG. 1, 110-114) to a user, and allows the user to place orders for the financial instrument with the exchange. Thus, the interface component 240 may serve as an interface between a user and one or more electronic exchanges (see FIG. 1, 110-114), to which the interface component 240 may be coupled through the communication component 260. An example of an interface component is shown in FIG. 3. The interface component 240 may include a market data interface module (or “interface module”) 350, and a user interface 310.

The user interface 310 communicates market information relating to a financial instrument to a user, and may allow the user to specify or select a price and/or quantity of interest. In addition, the user interface 310 may allow the user to communicate when an order for the financial instrument is to be placed. The user interface 310 may include any type of device capable of communicating digital information, such as a computer or terminal. The user interface 310 may, separately or in any combination, include an input device and an output device (not shown). The output device communicates the display to a user, and may include any type of visual, manual, audio, electronic or electromagnetic device capable of communicating information from a processor or memory device to a person or other processor or memory device. Examples of output devices include, but are not limited to, monitors, speakers, headphones, liquid crystal displays, networks, buses, and interfaces. The input device may include any type of visual, manual, mechanical, audio, and/or electromagnetic device capable of communicating information from a person and/or memory to a processor and/or memory. Examples of input devices include keyboards, microphones, voice recognition systems, trackballs, mice, networks, buses, and interfaces. The input and output devices may be included in a single device such as a touch screen, computer, processor or memory device.

The market data interface module 350 may receive data relating to a market for one or more financial instruments from the communication component 260 (FIG. 2) and process this information for communication to a user via the user interface 310. As processed by the market data interface module 350, the market is presented in a market-centered manner, in that the market for the financial instrument is kept generally central to the presentation. For example, if the user interface 310 includes a visual display device such as a monitor or projector, the market data interface module 350 prepares a visual display in which the market is approximately centered within the display. In addition, the market data interface module 350 may track a user-selected price for a financial instrument as the market for the financial instrument changes. Further, the market data interface module 350 may maintain a user-selected quantity for the financial instrument as the market changes.

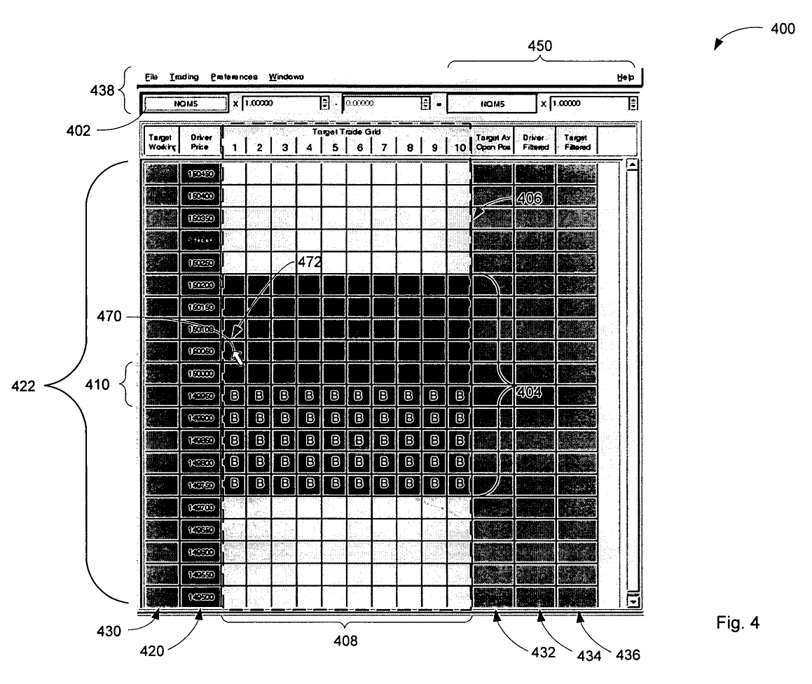

An example of a market-centered display created by the interface component 240 is shown in FIG. 4. The market-centered display 400 may include a dynamic price column 420, an order selection area 406, and areas for displaying and/or defining other market or trading information (“other information areas”) 438, 430, 434, and 436. The other information area 438 may include an identification 402, such as a name or symbol, identifying the financial instrument for which information is being displayed. In the example shown in FIG. 4, the identification 402 of the financial instrument being displayed is “NQM5.”

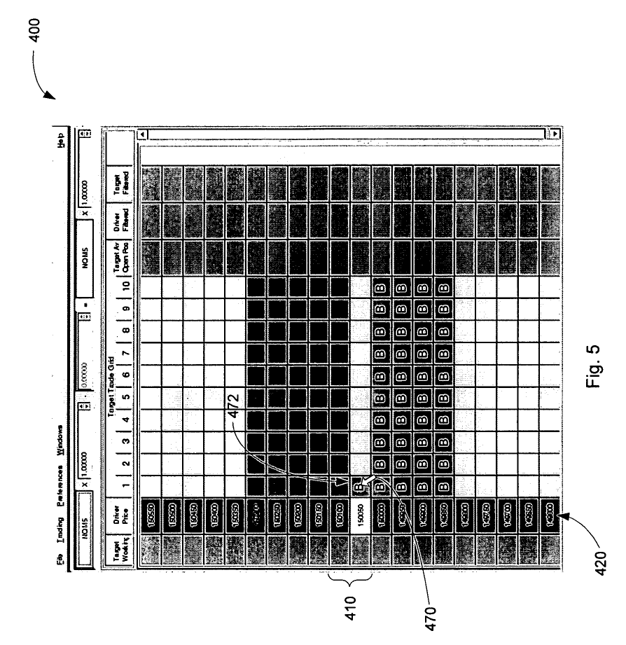

The price column 420 is dynamic in that the price levels move up and down and/or change as a function of the market. The dynamic price column 420 may include several cells each corresponding to a distinct price level. Each price level may be designated by a price or a price multiple in increments. In the example of FIG. 4, the increment is constant and equal to 50. However, the increment may include any value so that the price levels ascend or descend the dynamic price column 420. If the price level is designated by a price multiple, the price may be determined by multiplying the price multiple by a price factor. The price factor may include a default or user-defined value. The market-centered display 400 shown in FIGS. 4 and 5 is oriented in a vertical manner, in that the price levels in the dynamic price column 420 are arranged vertically with respect to each other, in other words, in a column. However, the market-centered display 400 may be oriented in a horizontal or other manner. For example, if oriented in a horizontal manner, the market-centered display 400 may include a horizontal dynamic price column with price levels arranged approximately horizontally with respect to each other, in other words, in a row.

The order selection area 406 may include several rows 422, and each row may be approximately horizontally aligned with a price level. In addition, the order selection area 406 may include one or more quantity columns 408, each of which may correspond to a particular quantity level. In FIG. 4, the quantity columns 408 correspond to (from left to right) quantity levels designated by values 1 through 10, as indicated at the top of each column. Alternately, the quantity levels may be designated by quantity multiples, in which case the quantity may be determined by multiplying the quantity multiple by a quantity factor. The quantity factor may include a default or user-defined value. The intersection of each row and each quantity column in the order selection area 406 may define an order selection block. In FIG. 4, the order selection blocks include a square shape. However, order selection blocks may include any shape. The order selection blocks together form a grid that makes up the order selection area 406. The number of rows 422 and columns 408 included in the order selection area 406 may be adjusted. However, the number of rows 422 and/or columns 408 may be limited by the size and type of the user interface 310 (FIG. 3) on which the display 400 is presented. Alternately, if the market-centered display 400 is oriented in a horizontal manner, each row 422 will be a column in vertical alignment with a price level, and each column 408 will be a row in horizontal alignment with the quantity levels.

Further, the order selection area 406 may include several indicators 404, which indicate price levels in the dynamic price column 420 that correspond to the market for the financial instrument (the “market price levels”). In general, there is at least one indicator associated with each market price level. The number of market price levels and thus, the number of indicators may be altered by the user to adjust the market depth represented in the display. However, the number of market price levels that may be displayed may be limited by the data relating to the market supplied by an exchange and/or the size of the user interface 310 (FIG. 3) on which the market centered display 400 is presented.

The indicators 404 may include a shading, color, character, alphanumeric and/or other designation that distinguishes the market price levels from the other price levels in the dynamic price column 420. For example, the indicators in FIG. 4 include a dark shading. In addition, some or all of the indicators may include an additional or alternate indication to identify the price levels that correspond to bids or asks. For example, in FIG. 4, some of the indicators include a “B” to indicate the price levels that correspond to bids. The asks are indicated by the remaining indicators (those that only include the black shading). However, the asks may also include an additional indicator such as “A.” Alternatively or additionally, the indicators associated with the bids may include a color, and those associated with asks may include a different color.

Multiple indicators may be associated with each price level. In the example shown in FIG. 4, the order selection area 406 includes ten (10) indicators for each price level arranged in approximate horizontal alignment with the corresponding price level. Alternately, the number of indicators included for each price level may vary to reflect the number of contracts actually available in the market at a given price. For example, as shown in FIG. 5, the row corresponding to the price level designated by 150050 includes an indicator 472 only with respect to the first quantity column. This indicator 472 also includes the additional indicator “B” indicating that the corresponding market price is that of a demand to buy one contract. The indicator 472 and additional indicator B in only the first column indicates that there is only demand to buy one (or a multiple of one) contract available in the market at the price of 150050 (or a multiple thereof).

Referring to FIGS. 3 and 4, the interface component 240 (see FIG. 3) produces the display 400 so that the information most important to a user, the market, is consistently approximately centered on the display 400 as indicated by the presence of one or more indicators in the rows of the market price levels. This provides a user with a view of the market at all times, without the need to readjust the display. For example, the market may be centered in the display according to the average price of the best bid and the best ask available in the market (the “inside market”). In this case, inside market 410 is consistently approximately centered in the display 400. To produce the display 400, the market data interface module 350 (FIG. 3) may average the best bid price and the best ask price to determine the approximate center of the display and the relative placement of the market price levels and the other price levels in the dynamic price column 420.

In FIG. 4, the market display is centered according to the inside market. When centered in this manner, the relative placement of the price levels includes the price levels corresponding to bids located on one side of the approximate center of the display and price levels corresponding to asks located on the other side, with the best bid and ask prices located closest to the approximate center. For example, in FIG. 4, the price for the inside market 410 are 149950 and 150000, which are centered vertically in display 400. Alternately, the market may be centered in the display horizontally, or according to other information such as bid prices, ask prices, most recent sale price (the most recent price at which a bid and ask were matched), and a spread. When centered according to bid prices, or ask prices, the market data interface module 350 (FIG. 3) may average the prices of the best bids, or the prices of the best asks, respectively, to determine the center of the display and the relative placement of the bid and ask prices. When centered according to the most recent sale price, the market data interface module 350 (FIG. 3) may identify the price of the most recent sale price to determine the center of the display and the relative placement of the bid prices and the ask prices. When centered according to the spread, the market data interface module 350 (FIG. 3) may identify the center of the spread to determine the center of the display and the relative placement of the rest of the spread. Alternately, to center the market according to bid or ask prices, the market data interface module 350 may place the price of the best bid or the best ask, respectively, in the approximate center of the display 400, and arrange the other prices and indicators accordingly. In some cases, the averaging used to center the market yields an unacceptable value (a value that does not correspond to an integer multiple of the price increment). In this case, the market data interface module 350 (FIG. 3) may round the unacceptable value either up or down in a consistent manner, to the nearest integer multiple of the increment.

The order selection area 406, together with the user interface 310, facilitates order selection by enabling a user to select a price on the dynamic price column 420, and then tracks that selection as the market changes. In addition, the order selection area 406 and the user interface 310 may facilitate order selection by enabling a user to select a quantity in one of the quantity columns 408 that corresponds with a price on the dynamic price column 420, and then tracks both the price and quantity. A user may select a price and/or quantity by communicating such a selection to the market data interface module 350 through the user interface 310. A user may use an input device, such as a mouse, touch screen, voice recognition system, keyboard, or wireless pointing device to select an order selection block that is aligned horizontally with the desired price and vertically with the desired quantity. In this manner, an order for a financial instrument may be selected. In the example of FIG. 4, the order selection block 472 has been selected by cursor 470. The order selection block 472 corresponds to the price “150050” and the quantity “1.” Alternatively, the user may select only a price by selecting a price level in the dynamic price column 420, for example by placing the cursor 470 over the price level that corresponds with the price of interest.

Because the market for a financial instrument is generally dynamic, the market data interface module 350 (FIG. 2) may track the order selection, so that the selected price and/or quantity are maintained over time. For example, FIG. 5 shows the display 400 of FIG. 4 at a later point in time. At the point in time represented in FIG. 5, the market has changed from the point in time represented in FIG. 4 so that the best ask and bid prices are now 150100 and 150050, respectively. Therefore, the price levels in the price column 420 have changed so that the inside market 410 is still in the center of the display 400. In addition, the market data interface module 350 (FIG. 2) has maintained or tracked the order selection, which is reflected by the user interface 350 that has maintained the cursor 470 with or on the order selection block 472 corresponding to price “150050” and quantity “1.”

The market data interface module 350 will continue to change the positions of the price levels along the dynamic price column 420 with the changing market so that the market prices remain in approximate alignment with the plurality of indicators 404, and the plurality of indicators 404 remain in approximately the same position in the order selection area 406. In addition, the market data interface module 350 will continue to track the order selection (as indicated by cursor 470 in FIGS. 4 and 5) until the user changes the order selection, cancels the order selection, or places an order.

A user may change the order selection by simply selecting another order selection block using the user interface 310 (FIG. 3). A user may cancel the order selection by de-selecting the order selection block 472 in the manner described above. For example, if the user interface 310 includes is a mouse and the order selection is indicated by a cursor 470 on the display 400, the user may de-select the order selection by moving the cursor 470 out of the order selection area 406 and the dynamic price column 420.

The other information areas 438, 430, 434, and 436 may include menus or the like that allow a user to specify other information according to one or more predefined parameters. These predefined parameters include, for example: price factors, quantity factors, average open position, working quantities, current profit or loss, quantity of filled orders, and cumulative traded quantities.

The display 400 may be customizable so that individual users or groups of users may alter the information and the manner in which the information is displayed. For example, the market for further financial instruments may be presented. Dynamic price columns and order selection areas for further financial instruments may be presented by including additional columns in the display 400. The market for each financial instrument presented in the display 400 may be separately centered according to bid prices, ask prices, averaged bid and ask prices, and the price of the last filled order. Alternately, one financial instrument may be centered as a function of, such as a mathematical relationship with, another financial instrument. For example, if one financial instrument (a “target”) is viewed as a function (the “spread”) of another financial instrument (a “driver”), the target may be centered according to the spread. This allows deviations from the spread to be more easily viewed. If the display 400 includes the market for an additional financial instrument, the other information area 438 may include an area for displaying a name, symbol or designation identifying the second financial instrument 450.

Referring to FIG. 3, the market data interface module 350 allows a user to specify order information. For example, orders may be set as limit, fill or kill, immediate or cancel, timed, iceberg, or market. In addition, order information may include routing, exchange specific directives, originating user and account may also be set. Referring to FIG. 2, the order component 290 may initiate an order for a financial instrument in response to a selection by a user, by communicating order information to an exchange through the communication component 260. The order component 290 may receive price, quantity and other order information from the interface component 240 automatically. For example, a user may have specified the price and quantity information using a user interface 310 (FIG. 3), such as by placement of a cursor, as described above. Further, the user may have set predefined parameters specifying other order information. Because the order component 290 receives this predefined information automatically, all that remains is to be specified is whether the order is a bid or an ask, and when initiation of the order is to commence.

Referring to FIGS. 2 and 3, a user may indicate when order placement is to be initiated by the order component 290 by using the user interface 310. For example, the user may click on a mouse, tap on a touch screen or performing some other action. To indicate whether the order is for a bid or an ask, the user may choose from one of two separate actions in connection with the user interface 310. For example, the user may left-click on the mouse to place a bid, and right-click on the mouse to place an ask. In another example, the user may tap once on a touch screen or click once on a mouse to place a bid and tap twice on the touch screen or click twice on the mouse to place an ask. No matter how the order placement is initiated, the selected price and quantity are maintained or tracked so that the order is placed for the intended price and quantity. In response to the initiation of an order, the order component 290 may communicate the order information to an exchange. After an order has been initiated, the interface component 240 may continue to track the selected price and/or quantity until the user de-selects the corresponding order selection block or selects another order selection block.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system for electronically tracking one of a plurality of prices, a subset of which corresponds to a market for a financial instrument traded on an exchange, the system comprising:
an interface module configured to statically display a plurality of indicators that identify the subset, and to dynamically display the plurality of prices with respect to the plurality of indicators; and
a user interface configured to receive a command to track one of the plurality of prices; and wherein the interface module is further configured to track one of the plurality of prices in response to the command to track.

2. The system of claim 1, wherein the user interface is further configured to statically display the plurality of indicators in an approximate center of a display.

3. The system of claim 1, wherein the indicators further identify a quantity corresponding to the plurality of prices.

4. The system of claim 3, wherein the interface module is further configured to track one of the plurality of indicators in response to a command to track one of the plurality of prices and the quantity corresponding to the one of the plurality of prices.

5. The system of claim 1, wherein the user interface is further configured to receive a command to place an order for the financial instrument with the exchange.

6. The system of claim 5 further comprising an order component configured to initiate placement of the order for the financial instrument in response to the user interface receiving the command to place the order.

7. The system of claim 1 further comprising a communication component configured to communicate with the exchange.

8. A system for electronically initiating the placement of an order for a financial instrument with an exchange, the system comprising:
an interface module configured to display a plurality of prices, statically display a plurality of indicators that identify a subset of the plurality of prices corresponding to a market for the financial instrument, and to dynamically display the plurality of prices with respect to the plurality of indicators;
a user interface configured to receive a command to place an order for the financial instrument with the exchange; and
an order component in communication with the exchange, and configured to initiate placement of the order with the exchange in response to receiving the command to initiate placement of the order.

9. Software including computer-executable instructions implementing a method for electronically tracking one of a plurality of prices, a subset of which corresponds to a market for a financial instrument traded on an exchange, the method comprising:
statically displaying a plurality of indicators identifying the subset;
dynamically displaying a plurality of prices with respect to the plurality of indicators; and
tracking one of the plurality of prices as the market changes in response to a command to track one of the plurality of prices.

10. Software including computer-executable instructions implementing a method for initiating placement of an order for a financial instrument with an exchange, the method comprising:
displaying a plurality of prices;
statically displaying a plurality of indicators that identify a subset of the plurality of prices corresponding to a market for the financial instrument, and dynamically displaying the plurality of prices with respect to the plurality of indicators; and
initiating placement of the order with the exchange in response to a command to initiate placement of the order.

11. A method for electronically tracking one of a plurality of prices, a subset of which corresponds to a market for a financial instrument traded on an exchange, the method comprising:
statically displaying a plurality of indicators identifying the subset;
dynamically displaying the plurality of prices with respect to the plurality of indicators; and
tracking one of the plurality of prices as the market changes in response to a command to track one of the plurality of prices.

12. The method of claim 11, wherein the plurality of indicators are statically displayed in an approximate center of a display.

13. The method of claim 11, wherein the plurality of indicators further identify a quantity associated with one of the plurality of prices.

14. The method of claim 13 further comprising tracking the quantity associated with the one of the plurality of prices in response to a selection of one of the plurality of indicators.

15. A method for electronically initiating placement of an order for a financial instrument with an exchange, the method comprising:
displaying a plurality of prices;
statically displaying a plurality of indicators that identify a subset of the plurality of prices corresponding to the market for the financial instrument, and dynamically displaying the plurality of prices with respect to the plurality of indicators; and
initiating placement of the order with the exchange in response to a command to initiate placement of the order.

16. A method for electronically tracking one of a plurality of prices, a subset of which corresponds to a market for a financial instrument traded on an exchange, the method comprising:
statically displaying a plurality of indicators that identify the subset, and dynamically displaying the plurality of prices with respect to the plurality of indicators; and
communicating a command to track one of the plurality of prices.

17. The method of claim 16, wherein communicating the command to track includes selecting the one of the plurality of prices.

18. The method of claim 16, wherein the indicators further identify a quantity corresponding to the plurality of prices.

19. The method of claim 18 further comprising communicating a command to track the quantity corresponding to the one of the plurality of prices.

20. The method of claim 19 wherein communicating a command to track one of the plurality of prices and the quantity corresponding to the one of the plurality of prices includes selecting one of the plurality of indicators.

21. A method for electronically initiating placement of an order for a financial instrument with an exchange, the method comprising:
displaying a plurality of prices,
statically displaying a plurality of indicators that identify a subset of the plurality of prices corresponding to a market for the financial instrument, and dynamically displaying the plurality of prices with respect to the plurality of indicators; and
communicating a command to initiate placement of the order.
